(19) United States
(12) Patent Application Publication
(10) Pub. No.: US 2012/0102569 A1
(43) Pub. Date: Apr. 26, 2012

(54) Computer system analysis method and apparatus

(75) Inventor: Pavel Turbin, Jokela (FI)

(73) Assignee: F-Secure Corporation

(21) Appl. No.: 12/925,482

(22) Filed: Oct. 21, 2010

(51) Int. Cl. G06F 21/00

(52) U.S. Cl. 726/24

(57) ABSTRACT

A method of analysing a computer on which are installed a plurality of applications each comprising a set of inter-related objects. The method first comprises identifying a local dependency network for each of one or more of said applications, a local dependency network comprising at least a set of object paths and inter-object relationships. The (or each) local application dependency network is then compared against a database of known application dependency networks to determine whether the application associated with the local dependency network is known. The results of the comparison are then used to identify malware and/or orphan objects.

### TECHNICAL FIELD

The present invention relates to a method and apparatus for analysing computer systems and in particular for analysing applications installed on computer systems. In particular, though not necessarily, the present invention relates to a method and apparatus for utilizing said analysis in the detection and removal of malware, and also in system optimization.

### BACKGROUND

Malware is short for malicious software and is used as a term to refer to any software designed to infiltrate or damage a computer system without the owner's informed consent. Malware can include computer viruses, worms, trojan horses, rootkits, and spyware. In order to prevent problems associated with malware infections, many end users make use of anti-virus software to detect and possibly remove malware.

After installing on a user's system, malware often avoids detection by mimicking the filename of popular and/or commonplace existing legitimate software. An example of this is the Troj/Torpid-C downloader Trojan, which uses the name ‘winword.exe’, the typical process name of Microsoft Word. The Trojan processes are therefore unnoticeable on the Task Manager. Another technique used by malware to avoid detection is to generate random names for its executable files. The random names are obscure and may prevent anti-virus software from detecting malware by using patterns in file names. Similar stealth methods apply for registry paths and keys. Malware chooses random and common “run” key values.

Whilst there is always likely to be a place for pattern recognition based anti-virus engines (i.e. engines which look for malware “fingerprints”), these will remain slow and will be reactive rather than proactive, as the patterns indicative of malware must already be known or be predictable by the anti-virus engine.

### SUMMARY

It is an object of the present invention to provide a mechanism for detecting malware on a computer system and which relies upon the detection of networks of objects on the system, where a network of objects is, or may be, associated with a program, application, file, or the like. Some of these programs, applications, files etc, may be known and trusted, some may be known and untrusted, and some may be unknown.

According to a first aspect of the invention there is provided a method of analysing a computer on which are installed a plurality of applications each comprising a set of inter-related objects. The method first comprises identifying a local dependency network for each of one or more of said applications, a local dependency network comprising at least a set of object paths and inter-object relationships. The (or each) local application dependency network is then compared against a database of known application dependency networks to determine whether the application associated with the local dependency network is known. The results of the comparison are then used to identify malware and/or orphan objects.

Embodiments of the present invention may provide a faster method of scanning a computer for malware, and which may require significantly less processing power than conventional scanning methods. In addition, embodiments of the present invention may provide an improved method of removing malware from a computer. The entire dependency network for the malware application is identified and therefore it can be ensured that during deletion, all components of a malicious application are removed.

The inter-related objects may be one or more of executable files, data files, registry keys, registry values, registry data and launch points.

The method may further comprise identifying the paths of objects of a local application dependency network, and normalizing the paths to make them system independent.

The object paths of a local application dependency network may be identified by tracing activity when the installation program for an application is launched or by taking system snapshots before and after the installation of the application and identifying the differences between the two snapshots. Alternatively, a local application dependency network may be identified by:
for a given input object, performing a search for all other objects that are dependent upon the input object;
storing the paths of the input object and any other objects found by the search, and their inter-object relationships, in a results file;
recursively repeating these steps for each other object until no further dependent objects are found; and
normalizing the object paths within the results file.

The database of known application dependency networks may be populated by observing the installation of known applications to capture their dependency networks or alternatively by gathering application dependency networks from the local systems of a distributed client base.

The method may comprise carrying out said step of identifying a local dependency network for each of one or more of said applications at a client computer, and carrying out said step of comparing the or each local application dependency network against a database of known application dependency networks at a central server.

The method may further comprise, for application dependency networks that are unknown, performing a further malware scan of the objects belonging to the unknown application dependency networks. This further malware scan may comprise conventional anti-virus scanning techniques, for example one or both of:
performing a check on application binary certificates; and
running a heuristic analysis on objects identified in the unknown local application dependency networks.

The objects identified in the unknown local application dependency network may be removed from the client computer or otherwise made safe if the application is found to be malicious, possibly with the exception of objects shared with other known application dependency networks.

The application dependency network for an unknown local application that is found to be legitimate following said further malware scan may be entered into the database of known application dependency networks.

According to a second aspect of the invention, there is provided a computer program for causing a computer to perform the method of the first aspect of the invention.

According to a third aspect of the invention, there is provided a client computer. The client computer comprises a system scanner for identifying a local dependency network for each of one or more applications installed on the client computer, where a local application dependency network comprises at least a set of object paths and inter-object relationships. The client computer also comprises a result handler for obtaining the results of a comparison of the or each local application dependency network against a database of known application dependency networks to determine whether the application associated with the local application dependency network is known. The client computer further comprises a policing unit for using the results of the comparison to identify malware and/or orphan objects.

According to a fourth aspect of the invention, there is provided a server computer system for serving a multiplicity of client computers. The server computer system comprises a database of known application dependency networks, where each application dependency network comprises at least a set of object paths and inter-object relationships. The server computer also comprises a receiver for receiving local application dependency networks from one or more of said client computers. A dependency network comparator is provided for comparing the received local application dependency networks against the known application dependency networks in the database to determine whether associated local applications are known. The server computer also comprises a transmitter for sending the results of the comparisons to the respective client computers.

### BRIEF DESCRIPTION OF THE DRAWINGS

FIG. 1 is a flow diagram illustrating a process of identifying an application dependency network according to an embodiment of the invention;

FIG. 2 is a flow diagram illustrating a process of performing the detection and removal of malicious software according to an embodiment of the invention;

FIG. 3 is a flow diagram illustrating an enhanced process of performing the detection and removal of malicious software which also detects and removes lost fragments according to an embodiment of the invention; and

FIG. 4 illustrates schematically a computer system according to an embodiment of the present invention.

### DETAILED DESCRIPTION

The malware scanning approach described here is presented in the context of a computer system comprising one or more central servers and a multiplicity of client computers. The client computers communicate with the central server(s) via the Internet. Other computer system architectures in which the approach could be employed will be readily apparent to the skilled person.

An application on a client computer usually consists of a set of associated objects including at least data files, directories and registry information (the latter including configuration and settings for the application)—a desktop shortcut points to the application executable file; the application executable file is stored in a directory where other application files and libraries are located; the application registry points to the location of data files and other executables which the application needs to run. The set of associated objects and their relationships can be thought of as a “dependency network” for the application.

It will be appreciated that, regardless of object names, absolute paths etc, a given application will construct, on installation, a given application dependency network, regardless of the configuration of the client computer on which it is installed (assuming that the same operating systems are used on the different client computers). In other words, the application dependency network for the application is computer independent. Application dependency networks can therefore be useful in an anti-virus scanning engine to identify malware.

There are a number of ways of identifying the dependency network for a given application. Two such methods are presented first which can be employed during installation of the application.

A first method is to trace the installer activity on the client computer. To do this, the installation program is launched within a managed environment so that a filter driver can watch any activity and trace all objects such as files, directories and registry information that are created by the installer or its child processes. A filter driver is a low-level component, for example, a file system driver, which can capture and record file operations such as the creation of a file or directory and modifying or renaming files.

The second method is to use system snapshot “diffing”. With this second method, system snapshots are taken on the client computer before and after the installation of the application. The snapshots will include files, directories and registry information. By identifying the differences between the two snapshots, the objects created by the installer during the installation process can be identified. Once the newly installed objects are identified, regardless of the method employed to do this, it is necessary to determine the relationships between the objects, e.g. object A points to object B, etc. The object paths, together with the inter-object relationships, define the application dependency network.

All methods of identifying an application dependency network will return at least a list of object paths created by the installer. In order to make the paths computer agnostic, they first have to be normalized, as other computers may have different configurations. The normalization process replaces the directories for the application installation folder, temp directory, user profile directory, system director and so on with a fixed keyword. For example:

% INSTALL_DIR %—is the normalized path where the application is installed. On a particular computer it could be resolved into the actual installation directory for instance “c:\Program Files\Mozilla Firefox”.

After normalization, the application dependency network will comprise object paths such as:

%INSTALL_DIR%\firefox.exe

### %INSTALL_DIR%\xul.dll

### %INSTALL_DIR%\AccessibleMarshal.dll

%INSTALL_DIR%\application.ini

### %USER_PROFILE%\Application Data\Mozilla\Firefox\

Furthermore it can comprise normalized object paths relating to registry keys, launch points and values, such as:

HKEY_CLASSES_ROOT\.htm \OpenWithList\firefox.exe

### HKEY_CLASSES_ROOT\.xht

HKEY_CLASSES_ROOT\Applications\firefox.exe\shell\open\command
(Default value),REG_SZ, “%INSTALL_DIR%\firefox.exe-requestPending-osint-url “% 1”

As indicated above, objects will have relationships between them that also contribute to defining the application dependency network. To identify these relationships, object dependency information is used. For example, using the above object examples, whenever a user clicks on a file with the extension .xht, firefox.exe will be launched. This is because .xht files are dependent on firefox.exe. Therefore an inter-object relationship can be identified between the object “%INSTALL_DIR%\firefox.exe and the registry key object HKEY_CLASSES_ROOT\.xht. If there is an application dependency network on a computer which contains %INSTALL_DIR %\firefox.exe but there is no corresponding relationship with HKEY_CLASSES_ROOT\.xht, then it could mean that an application is trying to mimic the legitimate Firefox application or that the legitimate Firefox application has not been installed or uninstalled properly.

The above methods of identifying the application dependency networks can of course only be employed if the anti-virus scanning engine is installed and running on a client computer when the new application is being installed. In order to scan previously installed applications, i.e. installed prior to installation of the scanning engine, or to identify malware that has managed to install itself without triggering the anti-virus scan, an alternative approach is required and which is able to determine a previously created application dependency network. This alternative approach can also enable the anti-virus scanning engine to carry out a full system scan on the client computer to determine all objects and relationships currently on the client computer. This full system scan will return application dependency networks for all applications already installed on the client computer (local application dependency networks) as well as any remaining objects and inter-object relationships which are not part of a complete application dependency network.

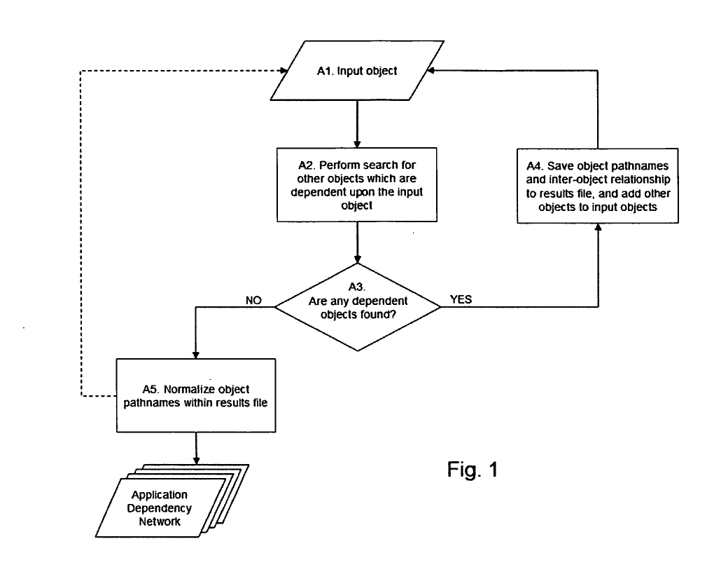

FIG. 1 is a flow diagram illustrating this alternative method. The key steps of this method are as follows:
A1. The client computer starts with an input object (that is as defined by the object's path). This might be any object on the system or an intelligently chosen object, e.g. a .exe file.
A2. The client computer carries out a search for all other objects which are dependent upon the input object. For example, using the examples given above, a search carried out on the firefox application path will find that the .xht extension registry key is dependent upon the firefox application.
A3. The client computer determines whether there are any results from the search.
A4. If there are results, the client computer stores the path of these other objects and their inter-object relationships in a results file. The steps A1 to A4 are then repeated recursively for each other object until no further dependent objects are found. The search therefore branches out until all objects within the dependency network are found. The search for dependent objects will usually follow a set of rules, for example:

TABLE 1

| Input | Dependent items |
|---|---|
| Path to executable | DLL Modules loaded into the |
| | executable if it is running |
| | Child processes if the executable if it is |
| | running |
| | Registry “launch points” pointing the |
| | executable |
| | Menu and desktop shortcuts |
| | Executable home directory |
| | COM registration for given path: |
| | HKEY_CLASSES_ROOT\ CLSID, |
| | HKEY_CLASSES_ROOT\ InterfaceID |
| | Application meta data under |
| | HKLM\Software |
| Path to DLL | List of processes loading the DLL |
| | Registry launch points stated rundll32 |
| | COM registration for given path |
| | Application meta data under |
| | HKLM\Software |

A5. When no further results are returned at step A3, the client computer normalizes the object paths within the results file (as discussed above). The contents of this results file is the application dependency network. The contents may be normalised object paths and inter-object relationships which are not part of a complete application dependency network, but they will be identified as a local application dependency network at this stage.

During a full system scan, the steps of this method are repeated (as shown by the dashed arrow in FIG. 1) until all objects of interest have been added to at least one dependency network. Of course, some application dependency networks may include only one or a small number of objects (paths), e.g. where these objects are fragments remaining left over following an incomplete uninstall operation.

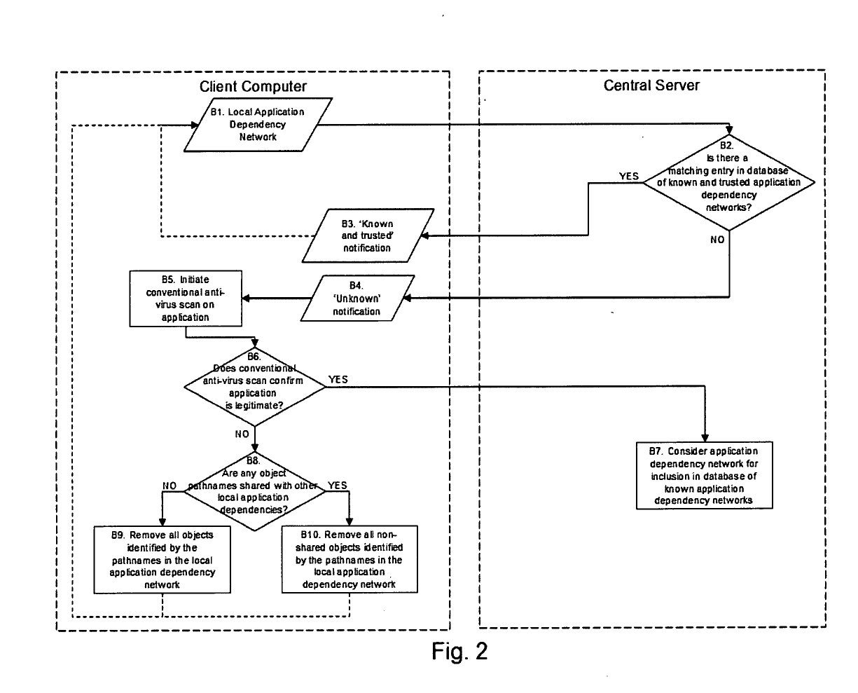

FIG. 2 is a flow diagram illustrating a second phase in the anti-virus scanning method. The steps performed are as follows, where the steps on the left of FIG. 2 are those carried out at the client computer and those on the right of FIG. 2 are carried out at a central server:
B1. The second phase starts by selecting a first of the local application dependency networks as identified in phase 1, which the client computer sends to a central server.
B2. The central server searches a database of known and trusted application dependency networks for an entry that matches the local application dependency network, and accordingly sends a notification back to the client computer as to whether the local application dependency network is known and trusted, or unknown.
B3. If the client computer receives a ‘known and trusted’ notification, the anti-virus scanning engine can start the method again at step B1 for a further selected local application dependency network as identified in phase 1 (as indicated by the dashed arrow in FIG. 2).
B4. If the client computer receives an ‘unknown’ notification, the anti-virus scanning engine proceeds to step B5.
B5. The anti-virus scanning engine then initiates a conventional anti-virus scan (e.g. employing an application binary check and/or heuristic analysis) on the application to which the local application dependency network corresponds.
B6. The anti-virus scanning engine determines from the conventional anti-virus scan in step B5 whether the application is legitimate.
B7. If the application is determined as being legitimate then the client computer sends a message to the central server which in turn will add the unknown application dependency network as an entry in the database of known and trusted application dependency networks (or consider it for inclusion based upon further analysis at the central server an/or based upon aggregated responses from all users).
B8. If the application is not determined to be legitimate in step B5, the anti-virus scanning engine determines whether any of the object paths in the local application dependency network are shared with any other local application dependency networks.
B9. If there are no shared object paths, the anti-virus scanning engine removes or otherwise makes safe all objects identified by the paths in the application dependency network from the client computer.
B10. If there are shared object paths, the anti-virus scanning engine removes from the client computer, or otherwise makes safe, all objects identified by the paths in the application dependency network that are not shared, and leaves the shared objects.

The method employed by the anti-virus scanning engine in the second phase as described above significantly cuts down the time taken in running the more conventional application binary checks and running heuristic analysis techniques. Here, the anti-virus scanning engine can first quickly determine whether a full conventional anti-virus scan on the application is required, and if it isn't due to the application being already known and trusted then it can promptly move on to another application. This method also provides a high quality removal process as the entire malicious application identified by its dependency network is removed from system, ensuring that all components of a malicious application get deleted.

The second phase of the method (FIG. 2) may include steps where the central server initiates a search in a database of known and untrusted application dependency networks for an entry that matches with the local application dependency network sent by the client computer. If a matching entry is found then the server sends a notification to the client computer identifying the local application dependency network as known and untrusted. The anti-virus scanning engine can then remove the application in accordance with steps B8 to B10 as described above. If a matching entry is not found in the database of known and untrusted application dependency networks, then the server sends a notification to the client computer identifying the local application dependency network as unknown. The anti-virus scanning engine then initiates a conventional anti-virus scan (e.g. employing an application binary check and/or heuristic analysis) on the application to which the local application dependency network corresponds. If the anti-virus scanning engine determines from this conventional anti-virus scan that the application is not legitimate, the client computer sends a message to the central server which in turn will consider adding the unknown application dependency network as an entry in the database of known and untrusted application dependency networks. The anti-virus engine can then remove the application in accordance with steps B8 to B10 as described above.

This further embodiment can be used as an alternative to the second phase method described in steps B1 to B10, or in conjunction with it. It would be preferable to be used in conjunction with the method in B1 to B10 as this would further cut down the time taken in running the more conventional methods of checking application binary certificates and running heuristic analysis techniques.

As well as malicious software, another problem that affects computer systems is that of ‘lost fragments’. Lost fragments, which are sometimes known as orphan files, are data files, downloaded updates and other fragments of an application that can be left behind after an application is uninstalled from a computer system, or if an application is not installed correctly. These lost fragments can build up over time and can occupy a large amount of disk space, reducing the useful storage capacity available to the user. Lost fragments are not always easy to detect, as often it is not clear which application they belong to. Furthermore, what at first may appear to be a lost fragment from one uninstalled application may actually be an object that is shared with one or more other applications still installed on the computer system. This makes deleting lost fragments difficult as a user may not want to delete fragments for fear of removing something that will cause another application to stop working.

The lost fragments on a client computer will correspond to the remaining object paths and inter-object relationships which are not part of a complete application dependency network as picked up by the anti-virus scanning engine in the first phase described above. At the end of the first phase, they are identified as a normal local application dependency network.

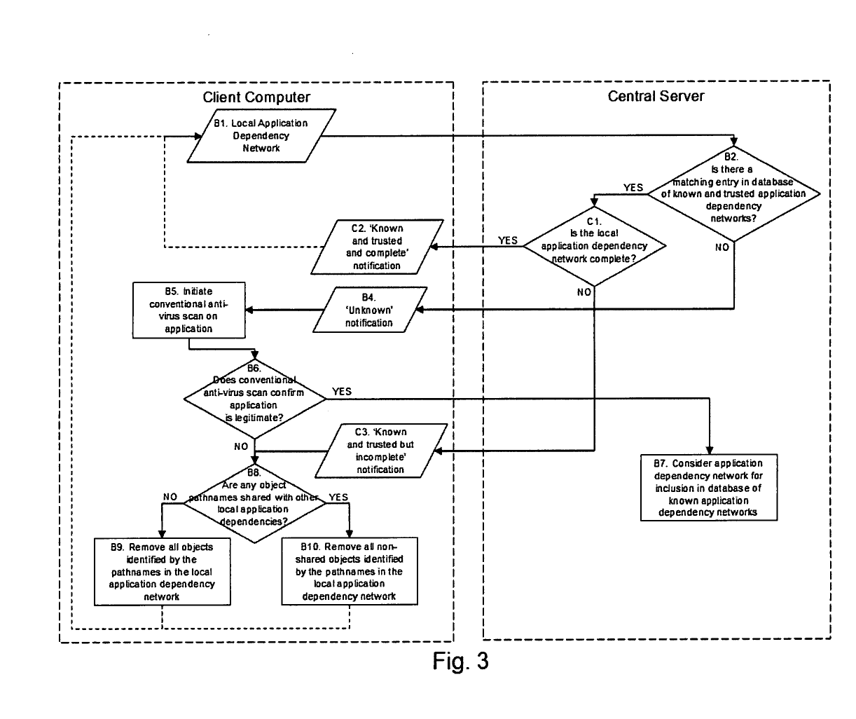

FIG. 3 is a flow diagram illustrating an enhanced process of performing the detection and removal of malicious software which also detects and removes lost fragments. The steps performed are the same as B1 to B10 as described above, but step B3 is replaced by C2, and extra steps C1 and C3 are introduced after step B2. The extra steps are performed as follows:
C1. After the server has found a matching entry (in step B2), the server performs a verification check to determine whether all expected application executables and modules as identified in the known application dependency network in the database are present in the local application dependency network. The server then sends a notification back to the client computer as to whether the local application dependency network is ‘known and trusted and complete’, or ‘known and trusted but incomplete’.
C2. If the client computer receives a ‘known and trusted and complete’ notification, the anti-virus scanning engine can start the method again at step B1 for a further selected local application dependency network as identified in phase 1 (as indicated by the dashed arrow in FIG. 3)
C3. If the client computer receives a ‘known and trusted but incomplete’ notification, the anti-virus scanning engine can remove the lost fragments in accordance with steps B8 to B10 as described above.

Alternatively, after step C3 the user may be asked to make the final decision as to whether the lost fragments are deleted or not, before proceeding to steps B8 to B10.

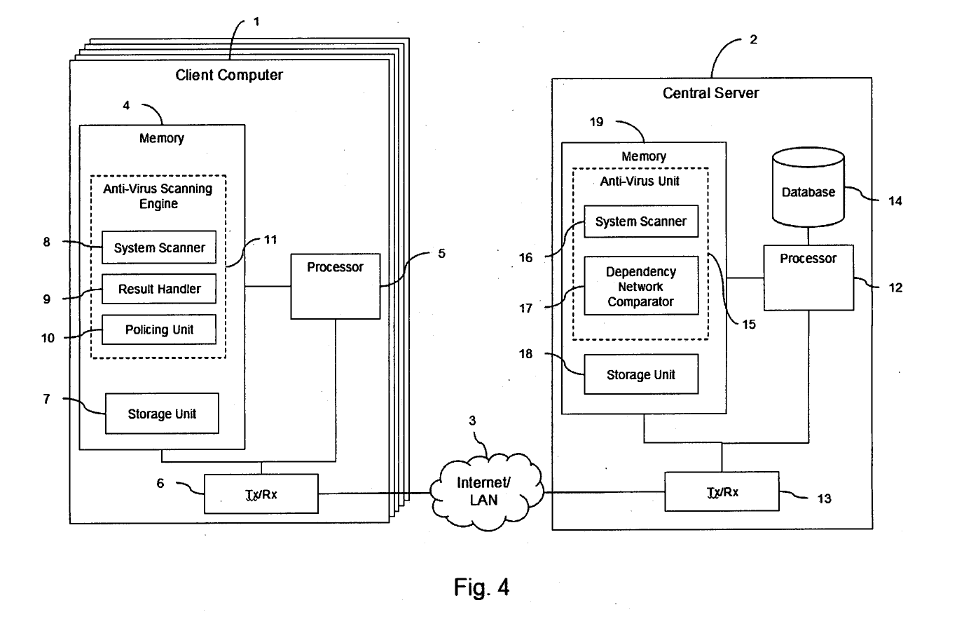

FIG. 4 illustrates schematically a computer system according to an embodiment of the present invention. The computer system comprises at least one client computer 1 connected to a central server 2 over a network 3 such as the Internet or a LAN. The client computer 1 can be implemented as a combination of computer hardware and software. A client computer 1 comprises a memory 4, a processor 5 and a transceiver 6. The memory 4 stores the various programs/executable files that are implemented by the processor 5, and also provides a storage unit 7 for any required data. The programs/executable files stored in the memory 4, and implemented by the processor 5, include a system scanner 8, a result handler 9 and a policing unit 10, all of which can be sub-units of an anti-virus scanning engine 11. The transceiver 6 is used to communicate with the central anti-virus server 2 over the network 3. Typically, the client computers 1 may be any of a desktop personal computer (PC), laptop, personal data assistant (PDA) or mobile phone, or any other suitable device.

The central server 2 is typically operated by the provider of the anti-virus scanning engine 11 that is run on the client computer 1. Alternatively, the central server 2 may be that of a network administrator or supervisor, the client computer 1 being part of the network for which the supervisor is responsible. The central server 2 can be implemented as a combination of computer hardware and software. The central server 2 comprises a memory 19, a processor 12, a transceiver 13 and a database 14. The memory 19 stores the various programs/executable files that are implemented by the processor 12, and also provides a storage unit 18 for any required data. The programs/executable files stored in the memory 19, and implemented by the processor 12, include a system scanner 16 and a dependency network comparator 17, both of which can be sub-units of an anti-virus unit 15. These programs/units may be the same as those programs implemented at the client computer 1, or may be different programs that are capable of interfacing and co-operating with the programs implemented at the client computer 1. The transceiver 13 is used to communicate with the client computer 1 over the network 3.

The database 14 stores known application dependency networks and may further store malware definition data, heuristic analysis rules, white lists, black lists etc. The database 14 can be populated with known application dependency networks by the server using the methods of identifying application dependency networks as described above in the first phase on the client computer. These methods are very precise, but would require a large amount of effort, not only to find the number of installers required to build a database up to a size which is practical, but also to run through each installer in order to capture the corresponding application's dependency network. Alternatively, database 14 can be populated with known application dependency networks by “crowd sourcing” the information. “Crowd sourcing” can be used if a large number of distributed clients submit local application dependency networks from their client computers. The server 2 receives the local application dependency networks via transceiver 13, stores it in memory 11 and groups the multiple identical networks submitted by the large number of distributed clients. When the number of submissions for any one given application reaches a predefined number, the server 2 indicates that the local application dependency network is valid and enters it into the database 14 of known application dependency networks. It is expected that database 14 is populated using a combination of these methods.

It will be appreciated by the person of skill in the art that various modifications may be made to the above described embodiments without departing from the scope of the present invention.

1. A method of analysing a computer on which are installed a plurality of applications each comprising a set of inter-related objects, the method comprising:
identifying a local dependency network for each of one or more of said applications, a local dependency network comprising at least a set of object paths and inter-object relationships;
comparing the or each local application dependency network against a database of known application dependency networks to determine whether the application associated with the local dependency network is known; and
using the results of the comparison to identify malware and/or orphan objects.

2. A method as claimed in claim 1, wherein said inter-related objects are one or more of executable files, data files, registry keys, registry values, registry data and launch points.

3. A method as claimed in claim 1 and comprising identifying the paths of objects of a local application dependency network, and normalizing the paths to make them system independent.

4. A method as claimed in claim 1, wherein the object paths of a local application dependency network are identified by tracing activity when the installation program for an application is launched.

5. A method as claimed in claim 1, wherein the object paths of a local application dependency network are identified by taking system snapshots before and after the installation of the application and identifying the differences between the two snapshots.

6. A method as claimed in claim 1, wherein a local application dependency network is identified by:
1) for a given input object, performing a search for all other objects dependent upon the input object;
2) storing the paths of the input object and any other objects found by the search, and their inter-object relationships, in a results file;
3) recursively repeating steps 1) and 2) for each other object until no further dependent objects are found; and
4) normalizing the object paths within the results file.

7. A method as claimed in claim 1, wherein the database of known application dependency networks is populated by observing the installation of known applications to capture their dependency networks.

8. A method as claimed in claim 1, wherein the database of known application dependency networks is populated by gathering application dependency networks from the local systems of a distributed client base.

9. A method according to claim 1 and comprising carrying out said step of identifying a local dependency network for each of one or more of said applications at a client computer, and carrying out said step of comparing the or each local application dependency network against a database of known application dependency networks at a central server.

10. A method according to claim 1 and comprising, for application dependency networks that are unknown, performing a further malware scan of the objects belonging to the unknown application dependency networks.

11. A method according to claim 10, wherein said further malware scan comprises one or both of:
performing a check on application binary certificates; and
running a heuristic analysis on objects identified in the unknown local application dependency networks; and
removing from the client computer or otherwise making safe the objects identified in the unknown local application dependency network if the application is found to be malicious.

12. A method as claimed in claim 10, wherein the application dependency network for an unknown local application that is found to be legitimate following said further malware scan is entered into the database of known application dependency networks.

13. A method according to claim 10, wherein said further malware scan comprises one or both of:
performing a check on an application binary certificate; and
running a heuristic analysis on objects identified in the unknown, local application dependency networks; and
removing from the client computer or otherwise making safe the objects identified in the unknown local application dependency network if the application is found to be malicious, with the exception of objects shared with other known application dependency networks.

14. A computer program for causing a computer to perform the method of claim 1.

15. A client computer comprising:
a system scanner for identifying a local dependency network for each of one or more applications installed on the client computer, a local application dependency network comprising at least a set of object paths and inter-object relationships;
a result handler for obtaining the results of a comparison of the or each local application dependency network against a database of known application dependency networks to determine whether the application associated with the local application dependency network is known; and
a policing unit for using the results of the comparison to identify malware and/or orphan objects.

16. A server computer system for serving a multiplicity of client computers, the server computer system comprising:
a database of known application dependency networks, each application dependency network including object paths and inter-object relationships;
a receiver for receiving local application dependency networks from one or more of said client computers;
a dependency network comparator for comparing the received local application dependency networks against the known application dependency networks in the database to determine whether associated local applications are known; and
a transmitter for sending the results of the comparisons to the respective client computers.
